(19) United States
(12) Patent Application Publication
(10) Pub. No.: US 2026/0155699 A1
(43) Pub. Date: Jun. 4, 2026

(54) MOTOR, MOTOR DEVICE, AND METHOD OF MANUFACTURING THE MOTOR DEVICE

(71) Applicant: DENSO CORPORATION, Kariya-city, (JP)

(72) Inventors: Kenji KANI, Kariya-city (JP); Tomohisa OKAMOTO, Kariya-city (JP)

(73) Assignee: DENSO CORPORATION, Kariya-city, (JP)

(21) Appl. No.: 19/454,798

(22) Filed: Jan. 21, 2026

Related U.S. Application Data
(63) Continuation of application No. PCT/JP2024/019419, filed on May 27, 2024.

(30) Foreign Application Priority Data
Jul. 26, 2023 (JP) 2023-122054

(51) Int. Cl. H02K 5/10; H02K 7/08; H02K 15/40

(52) U.S. Cl. CPC H02K 5/10; H02K 7/085; H02K 15/40

(57) ABSTRACT

A motor includes: a housing that accommodates a ball bearing; a shaft that is rotatably supported by the ball bearing and has a fixing portion at an end portion on one side of an axial direction of the shaft, a rotary member being fixed to the fixing portion by press-fitting; a case that has a shaft receiving portion facing an end portion on the other side of the axial direction of the shaft via a gap and a cover portion formed around the shaft receiving portion and having flexibility; and an intervening portion that is interposed between the housing and the cover portion.

### CROSS-REFERENCE TO RELATED APPLICATION

The present application is a continuation application of International Application No. PCT/JP 2024/019419, filed on May 27, 2024, which claims priority to Japanese Patent Application No. 2023-122054, filed in Japan on Jul. 26, 2023. The contents of these applications are incorporated herein by reference in their entirety.

### BACKGROUND

### 1. Technical Field

The present invention relates to a motor, a motor device, and a method of manufacturing the motor device.

### 2. Related Art

Japanese Patent No. 2520887 discloses an electrically driven device that includes: a bottomed cylindrical housing, a stator that is provided in the housing, a rotor that is disposed in the housing to be concentric with the stator; a rotating shaft to which the rotor is mounted, one end portion of the rotating shaft facing a bottom face of the housing, the other end portion of the rotating shaft being located outside the housing; a bearing that rotatably supports the rotating shaft in the housing; a flexible portion that is formed on the bottom face of the housing to be displaceable in an axial direction of the rotating shaft; a gap to which a minimum clearance is set, which is required for preventing interference between the flexible portion and the one end portion of the rotating shaft occurring when the rotating shaft rotates; and a driven member that is press-fitted in a direction from the other end portion to the one end portion and is fixed to the other end portion of the rotating shaft.

### SUMMARY

The present disclosure provides a motor. As an aspect of the technology of the present disclosure, a motor includes a housing, a shaft, a case, and an intervening portion. The housing accommodates a ball bearing. The shaft is rotatably supported by the ball bearing and has a fixing portion at an end portion on one side of an axial direction of the shaft, a rotary member being fixed to the fixing portion by press-fitting. The case has a shaft receiving portion facing an end portion on the other side of the axial direction of the shaft via a gap, and a cover portion formed around the shaft receiving portion and having flexibility. The intervening portion is interposed between the housing and the cover portion.

### BRIEF DESCRIPTION OF THE DRAWINGS

In the accompanying drawings:

FIG. 1 is a longitudinal sectional view schematically illustrating a motor device according to the present embodiment;

FIG. 2 is a drawing for describing a first step of a press-fitting process according to the present embodiment;

FIG. 3 is a drawing for describing a second step of the press-fitting process according to the present embodiment;

FIG. 4 is a drawing for describing a third step of the press-fitting process according to the present embodiment;

FIG. 5 is a graph illustrating a relationship between a displacement amount of a seal material and a load caused by the displacement of the seal material according to the present embodiment;

FIG. 6 is a longitudinal sectional view illustrating a case according to a first modification;

FIG. 7 is a graph illustrating a relationship between a displacement amount of a seal material and a load caused by the displacement of the seal material according to the first modification;

FIG. 8 is a longitudinal sectional view illustrating a case according to a second modification;

FIG. 9 is a graph illustrating a relationship between a displacement amount of a seal material and a load caused by the displacement of the seal material according to the second modification;

FIG. 10 is a longitudinal sectional view illustrating a motor device according to a third modification;

FIG. 11 is a graph illustrating a relationship between a displacement amount of a seal material and a load caused by the displacement of the seal material according to the third modification;

FIG. 12 is a longitudinal sectional view illustrating a motor device according to a fourth modification;

FIG. 13 is a longitudinal sectional view illustrating a motor device according to a fifth modification;

FIG. 14 is a longitudinal sectional view illustrating a motor device according to a sixth modification; and

FIG. 15 is a longitudinal sectional view illustrating a motor device according to a seventh modification.

### DETAILED DESCRIPTION OF THE PREFERRED EMBODIMENTS

As a result of detailed studies of the inventors, a point for improvement was identified in the configuration of the electrically driven device described in Japanese Patent No. 2520887, in which the flexible portion bends when the driven member is press-fitted, thereby supporting the rotating shaft by a stopper via the flexible portion. The point is that the flexible portion may be damaged while bending, whereby foreign matter or water may enter the interior of the housing through the damaged portion.

In view of the above point, the present disclosure has an object of providing a motor, a motor device, and a method of manufacturing the motor device that can suppress breakage of a shaft receiving portion when a rotary member is press-fitted to a shaft.

A first aspect of the present disclosure is a motor including:
a housing that accommodates a ball bearing;
a shaft that is rotatably supported by the ball bearing and has a fixing portion at an end portion on one side of an axial direction of the shaft, a rotary member being fixed to the fixing portion by press-fitting;
a case that has a shaft receiving portion facing an end portion on the other side of the axial direction of the shaft via a gap, and a cover portion formed around the shaft receiving portion and having flexibility; and
an intervening portion that is interposed between the housing and the cover portion.

A second aspect of the present disclosure is a motor device including: the motor according to the first aspect; and the rotary member.

A third aspect of the present disclosure is a method of manufacturing the motor device according to the second aspect, this method including a press-fitting process of fixing the rotary member to the end portion on the one side of the axial direction of the shaft by press-fitting, in which
in the press-fitting process,
a load during press-fitting of the rotary member is transmitted to the cover portion via the ball bearing, the housing, and the intervening portion, thereby bending the cover portion to bring the end portion on the other side of the axial direction of the shaft, via the shaft receiving portion, into contact with a jig, and
completing the press-fitting of the rotary member while the end portion on the other side of the axial direction of the shaft is in contact with the jig via the shaft receiving portion.

According to the present disclosure, a motor, a motor device, and a method of manufacturing the motor device are provided which can suppress breakage of a shaft receiving portion when a rotary member is press-fitted to a shaft.

### EMBODIMENTS

Hereinafter, an embodiment of the present disclosure will be described.

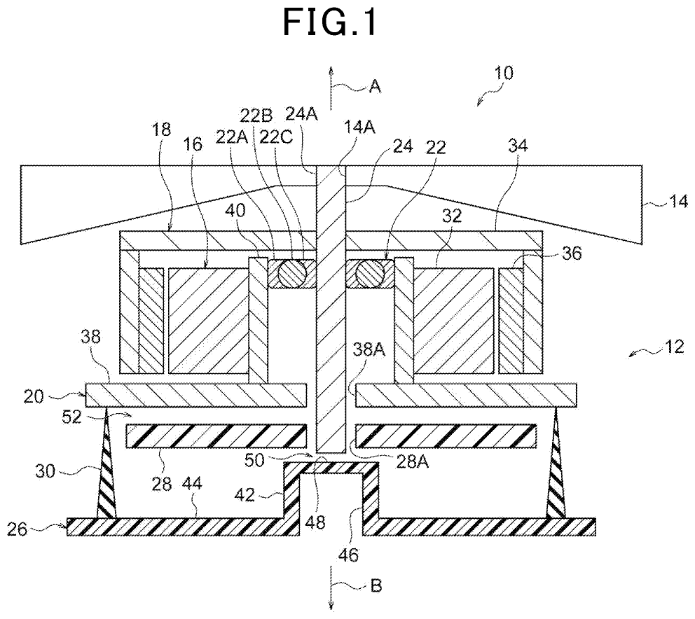

FIG. 1 is a longitudinal sectional view schematically illustrating a motor device 10 according to the present embodiment. The motor device 10 includes a motor 12 and a fan 14. The fan 14 is an example of a “rotary member” in the present disclosure. The motor 12 is, as an example, an outer rotor type brushless motor. The motor 12 includes a stator 16, a rotor 18, a housing 20, a ball bearing 22, a shaft 24, a case 26, a substrate 28, and a sealing material 30.

The side pointed by an arrow A indicates one side of the axial direction of the motor 12, and the side pointed by an arrow B indicates the other side of the axial direction of the motor 12. It is noted that, hereinafter, the one side of the axial direction of each portion is referred to as an “A side”, and the other side of the axial direction of each portion is referred to as a “B side”.

The stator 16 is configured to have an annular shape. The stator 16 has a stator core 32 and a winding (not shown). The stator core 32 is wound with the winding.

The rotor 18 has a rotor housing 34 and a rotor magnet 36. The rotor housing 34 is formed into a cylindrical shape with a closed end. The rotor magnet 36 is fixed to the inner peripheral surface of the rotor housing 34. Inside the rotor housing 34, the stator 16 is disposed. The rotor magnet 36 is disposed outside the stator 16 in the radial direction and faces the stator 16.

The housing 20 has a base portion 38 and a center piece 40. The base portion 38 is formed into a plate shape and is disposed in a state in which the plate thickness direction thereof agrees with the axial direction of the motor 12. The center piece 40 is disposed on the A side of the base portion 38. The center piece 40 is formed into a cylindrical shape and is disposed coaxially with the center axis line of the motor 12. The base portion 38 and the center piece 40 may be integrally formed or may be separate ones. Inside the stator core 32, the center piece 40 is press-fitted, whereby the stator 16 is supported by the center piece 40.

The ball bearing 22 is accommodated inside the center piece 40. The ball bearing 22 is disposed at an end portion of the center piece 40 on the A side. The ball bearing 22 has an outer ring 22A, a plurality of balls 22B, and an inner ring 22C. The outer ring 22A is press-fitted inside the center piece 40, whereby the ball bearing 22 is held by the center piece 40. The inner ring 22C is rotatably supported by the outer ring 22A via the plurality of balls 22B.

The shaft 24 is formed into a rod shape and is made of iron. The shaft 24 extends along the axial direction of the motor 12 and is disposed on the center axis line of the motor 12. The shaft 24 is press-fitted inside the inner ring 22C, whereby the shaft 24 is rotatably supported by the ball bearing 22. The rotor housing 34 is integrally rotatably fixed to the shaft 24. The end portion of the shaft 24 on the A side is formed as a fixing portion 24A for fixing the fan 14. The fixing portion 24A projects from the rotor housing 34 to the side pointed by the arrow A.

The fan 14 has a through hole 14A passing through in the axial direction of the fan 14. The through hole 14A penetrates along the center axis line of the fan 14. The fixing portion 24A is press-fitted into the through hole 14A, whereby the fan 14 is fixed to the fixing portion 24A. That is, the fan 14 is fixed to the fixing portion 24A from the A side by press-fitting.

The case 26 is disposed on the B side of the base portion 38. The case 26 has a bulging portion 42 and a cover portion 44. The bulging portion 42 is provided on the center axis line of the motor 12. The bulging portion 42 is formed into such a shape that part of the case 26 convexly bulges toward the A side. Inside the bulging portion 42, a concave portion 46 opening toward the B side is formed.

The top portion of the bulging portion 42 is formed as a shaft receiving portion 48 for receiving the shaft 24 when the fan 14 is press-fitted to the shaft 24. The shaft receiving portion 48 is formed to be flat and extends in the direction orthogonal to the center axis line of the motor 12. The shaft receiving portion 48 is formed into a circular shape when viewed in the axial direction of the motor 12. The shaft receiving portion 48 faces an end portion on the B side of the shaft 24 via a gap 50. The dimension of the gap 50 (i.e., a width dimension in the axial direction of the motor 12) is set to the minimum value of a dimension that ensures a clearance between the shaft 24 and the shaft receiving portion 48 even when the shaft 24 is displaced toward the B side due to deformation of the ball bearing 22 caused by the self-weight of the fan 14 (i.e, displacement of the inner ring 22C toward the B side with respect to the outer ring 22A).

The cover portion 44 is formed around the shaft receiving portion 48. Specifically, part of the case 26 other than the bulging portion 42 is the cover portion 44. The cover portion 44 is formed into a plate shape and is disposed in a state in which the plate thickness thereof agrees with the axial direction of the motor 12. The cover portion 44 is disposed on the B side of the base portion 38, facing the base portion 38. Between the base portion 38 and the cover portion 44, a space 52, which is described later, for accommodating the substrate 28 is formed.

The whole case 26 including the cover portion 44 is formed of resin. Hence, the cover portion 44 has flexibility. That is, as described later, the cover portion 44 is configured to bend toward the B side when a load is applied toward the B side by the sealing material 30 during press-fitting of the fan 14.

The substrate 28 is formed into a plate shape and is disposed in a state in which the plate thickness direction thereof agrees with the axial direction of the motor 12. Electronic components and the like for supplying current to the winding are mounted on the substrate 28. Through holes 28A and 38A passing through in the axial direction of the motor 12 are respectively formed in the substrate 28 and the base portion 38 described above. The part on the B side of the shaft 24 is inserted into each of the through holes 28A and 38A.

The sealing material 30 extends from the cover portion 44 to the base portion 38 and is interposed between the housing 20 (specifically, the cover portion 44) and the base portion 38. The end portion on the B side of the sealing material 30 is fixed to the cover portion 44. The end portion on the A side of the sealing material 30 is in contact with the base portion 38. The sealing material 30 is an example of an “intervening portion” of the present disclosure. The sealing material 30 is annularly formed along the outer periphery of the case 26 (specifically, the base portion 38) and surrounds the substrate 28. The sealing material 30 seals the space between the housing 20 and the cover portion 44 to seal the space 52.

The sealing material 30 has elasticity. The sealing material 30 may be formed of rubber or may be formed of elastomer. The sealing material 30 has a cross-sectional shape that tapers toward the A side. The sealing material 30 has, as described later, has sufficient rigidity to bend the cover portion 44 toward the B side by elastic deformation in the compression direction when a load is applied from the housing 20 during press-fitting of the fan 14. The sealing material 30 is set to have lower rigidity than the cover portion 44 to absorb the load applied to the ball bearing 22 during press-fitting of the fan 14. That is, when the displacement mount of the sealing material 30 in the compression direction and the displacement amount of the cover portion 44 in the bending direction (both are the displacement amounts of the motor 12 in the axial direction) are compared at the position where a load is applied from the housing 20 to the cover portion 44 via the sealing material 30, the displacement amount of the sealing material 30 in the compression direction is smaller than the displacement amount of the cover portion 44 in the bending direction.

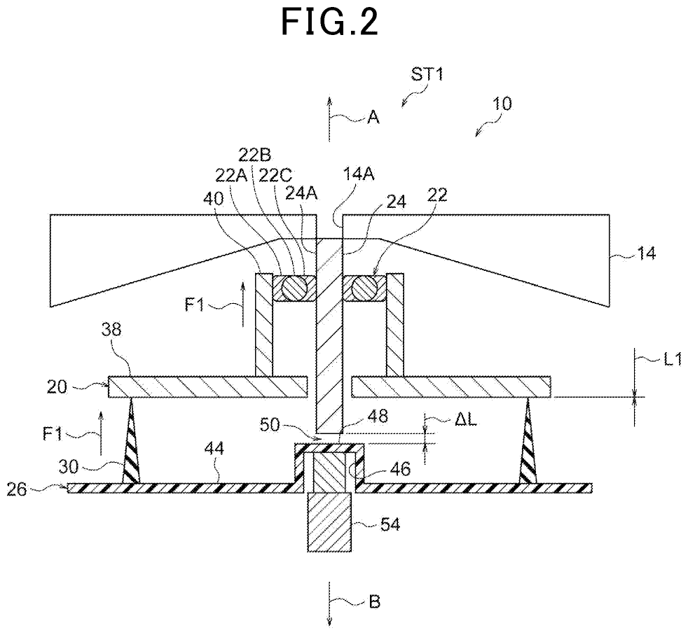

Next, with reference to FIG. 2 to FIG. 5, a method of manufacturing the motor device 10 according to the present embodiment will be described. It is noted that, in FIG. 2 to FIG. 5, the stator 16, the rotor 18, and the substrate 28 are not shown.

The method of manufacturing the motor device 10 according to the present embodiment is a method of manufacturing the motor device 10 by fixing the fan 14 to the shaft 24 using press-fitting, and includes a press-fitting process for press-fitting the fan 14. In the press-fitting process, the A side is defined as an upper side in the vertical direction. In addition, in the press-fitting process, a jig 54 is inserted in the concave portion 46 from the B side, and an end of the jig 54 is brought into contact with the shaft receiving portion 48 from the B side. Hereinafter, the press-fitting process will be described in detail by dividing it into a first step ST1, a second step ST2, and a third step ST3.

FIG. 2 is a drawing for describing the first step ST1. The first step ST1 is a step of setting the fan 14 to the fixing portion 24A to establish an initial state. In the first step ST1, against the self-weight of the fan 14, the sealing material 30 generates a load F1 as reaction force, and the load F1 is applied to the outer ring 22A of the ball bearing 22. In addition, in the first step ST1, the displacement amount of the sealing material 30 is a displacement amount L1 due to the self-weight of the fan 14, and the gap 50 having a dimension ΔL is ensured between the shaft 24 and the shaft receiving portion 48. It is noted that the displacement amount L1 includes a compressive deformation amount of the sealing material 30.

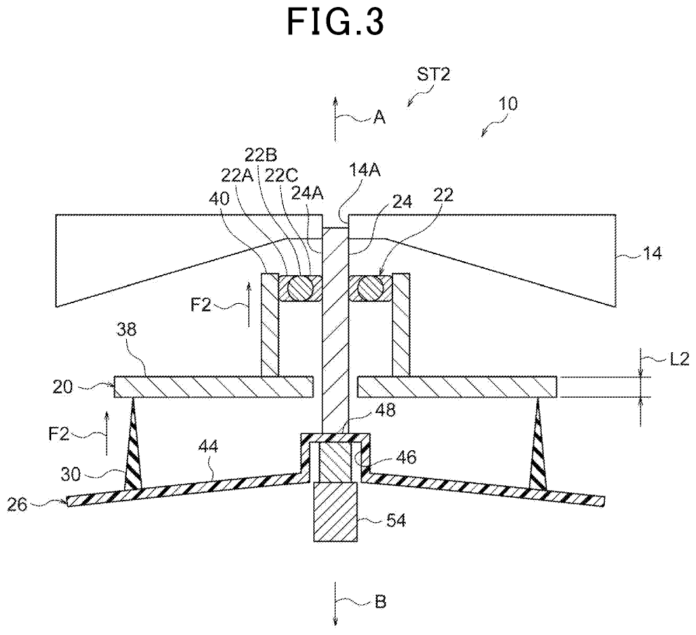

FIG. 3 is a drawing for describing the second step ST2. The second step ST2 is a step from the initial state to a state in which the shaft 24 is brought into contact with the jig 54 via the shaft receiving portion 48. That is, in the second step ST2, the load applied when the fan 14 is press-fitted is transferred to the cover portion 44 via the ball bearing 22, the housing 20, and the sealing material 30 to bend the cover portion 44 toward the B side, thereby bringing the shaft 24 into contact with the jig 54 via the shaft receiving portion 48.

In the second step ST2, when the press-fitting load is applied to the fan 14, the sealing material 30 generates a load F2 as reaction force, and the load F2 is applied to the outer ring 22A of the ball bearing 22. In addition, in the second step ST2, the displacement amount of the sealing material 30 is a displacement amount L2 due to the bending of the cover portion 44 caused until the shaft 24 is brought into contact with the jig 54 via the shaft receiving portion 48. It is noted that the displacement amount L2 includes a compressive deformation amount of the sealing material 30.

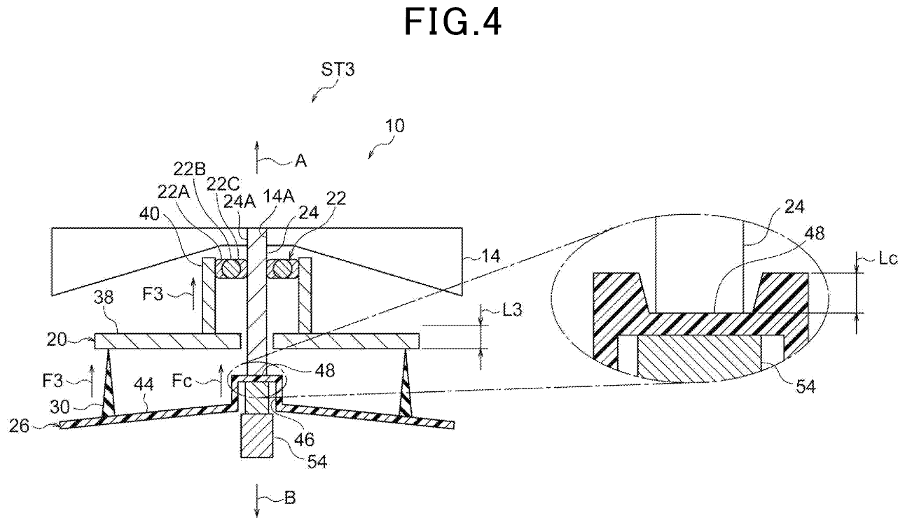

FIG. 4 is a drawing for describing the third step ST3. The third step ST3 is a step from the state in which the shaft 24 is brought into contact with the jig 54 via the shaft receiving portion 48 to a state in which the press-fitting of the fan 14 is completed. That is, in the third step ST3, in a state in which the position of the shaft 24 is held by bringing the shaft 24 into contact with the jig 54 via the shaft receiving portion 48, the fixing portion 24A of the shaft 24 is press-fitted to a predetermined position in the through hole 14A of the fan 14.

In the third step ST3, in the state in which the shaft 24 is brought into contact with the jig 54 via the shaft receiving portion 48, the press-fitting load is applied to the fan 14, whereby the shaft receiving portion 48 is deformed in the compression direction while the shaft receiving portion 48 generates a load Fc as reaction force. In this case, the deformation amount of the shaft receiving portion 48 is a deformation amount Lc. Against the deformation of the shaft receiving portion 48, the sealing material 30 generates a load F3 as reaction force. The load F3 is applied to the outer ring 22A of the ball bearing 22. In the third step ST3, the displacement amount of the sealing material 30 is a deformation amount L3 including a displacement amount due to the bending of the cover portion 44 and the deformation amount Lc of the shaft receiving portion 48. It is noted that the deformation amount L3 includes a compressive deformation amount of the sealing material 30.

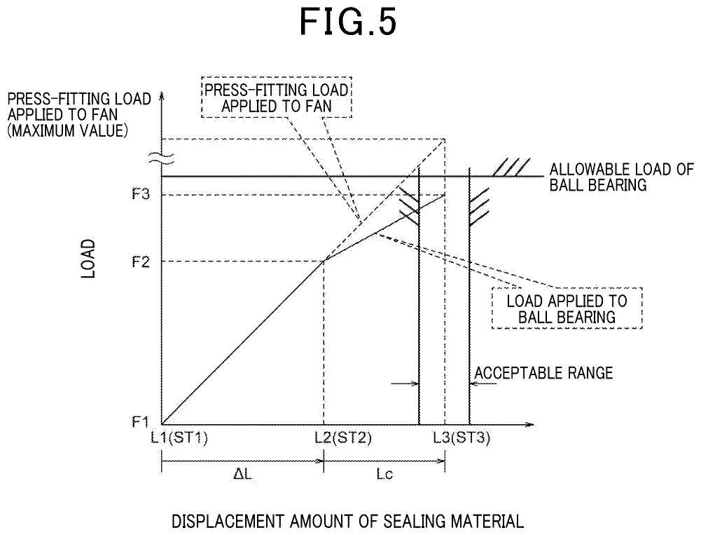

FIG. 5 is a graph illustrating a relationship between a displacement amount of the seal material 30 and a load caused by the displacement of the seal material 30 according to the present embodiment. As described above, in the first step ST1, the load F1 is applied to the outer ring 22A of the ball bearing 22, corresponding to the displacement amount L1 of the sealing material 30. In the second step ST2, the load F2 is applied to the outer ring 22A of the ball bearing 22, corresponding to the displacement amount L2 of the sealing material 30. In the third step ST3, the load F3 is applied to the outer ring 22A of the ball bearing 22, corresponding to the deformation amount L3 of the sealing material 30. The difference between the displacement amount L2 and the displacement amount L1 is substantially equal to the dimension ΔL between the shaft 24 and the shaft receiving portion 48. In addition, the difference between the deformation amount L3 and the displacement amount L2 is substantially equal to the displacement amount Lc, which is a compressive deformation amount of the shaft receiving portion 48. In the case of the deformation amount L3, the press-fitting load applied to the fan 14 reaches the maximum.

Herein, an allowable load in the thrust direction is set for the ball bearing 22. If the load applied to the ball bearing 22 exceeds the allowable load when the press-fitting load applied to the fan 14 has reached the maximum, the ball bearing 22 may be damaged.

However, according to the method of manufacturing the motor device 10 according to the present embodiment, from the second step ST2 to the third step ST3, even when the shaft receiving portion 48 is deformed in the compression direction, the sealing material 30 is elastically deformed in the compression direction, whereby the load applied to the ball bearing 22 is reduced. That is, compared with a gradient of the load from the first step ST1 to the second step ST2, a gradient of the load from the second step ST2 to the third step ST3 becomes gradual. Hence, the load applied to the ball bearing 22 is prevented from exceeding the allowable load.

In the present embodiment, rigidity of the sealing material 30 is set so that the load F3 corresponding to the deformation amount L3 falls below the allowable load. However, since the sealing material 30 includes a dimensional error, it is sufficient that the displacement amount corresponding to the load F3 falls within an acceptable range centered on the deformation amount L3. It is noted that, from the second step ST2 to the third step ST3, when the shaft receiving portion 48 deforms in the compression direction, the load applied to the ball bearing 22 is also reduced by the cover portion 44 bending toward the B side.

Next, effects of the present embodiment will be described.

As described above in detail, in the present embodiment, the case 26 has the shaft receiving portion 48 that faces the end portion of the shaft 24 on the B side via the gap 50 and the cover portion 44 that is formed around the shaft receiving portion 48 and has flexibility. The sealing material 30 is interposed between the housing 20 and the cover portion 44. Then, in the press-fitting process of the fan 14, the load applied when the fan 14 is press-fitted is transferred to the cover portion 44 via the ball bearing 22, the housing 20, and the sealing material 30 to bend the cover portion 44, whereby the shaft 24 can be brought into contact with the jig 54 via the shaft receiving portion 48. Hence, for example, compared with a case in which the shaft receiving portion 48 is bent by the amount of the gap 50 between the shaft 24 and the shaft receiving portion 48, the deformation amount of the shaft receiving portion 48 caused when the fan 14 is press-fitted can be suppressed. Hence, breakage of the shaft receiving portion 48 can be suppressed when the fan 14 is press-fitted.

In addition, the case 26 has the shaft receiving portion 48. Herein, it can be considered that a through hole is provided instead of the shaft receiving portion 48, the shaft 24 is inserted into the through hole, and the jig 54 directly receives the shaft 24. However, in this case, a member for closing the through hole is required, thereby increasing costs. In addition, foreign matter or water may enter through the through hole. In this regard, in the present embodiment, since the case 26 has the shaft receiving portion 48, compared with the case of having the through hole, increase of the number of components can be suppressed, and furthermore, costs can be decreased. In addition, since the case 26 has no through hole, foreign matter or water can be prevented from entering through the through hole.

In addition, the shaft receiving portion 48 is formed in the case 26. Hence, compared with a case in which the shaft receiving portion 48 is separated from the case 26, the number of components can be reduced, whereby costs can be decreased.

In addition, the sealing material 30 has elasticity. Hence, in the press-fitting process, even when the shaft receiving portion 48 is deformed in the compression direction, the sealing material 30 is elastically deformed, whereby the load applied to the ball bearing 22 can be reduced. Accordingly, since the load applied to the ball bearing 22 can be prevented from exceeding the allowable load of the ball bearing 22, breakage of the ball bearing 22 can be suppressed.

In addition, to reduce the load applied to the ball bearing 22, the sealing material 30 is used. Hence, compared with a case of using a member for reducing the load instead of the sealing material 30, the number of components can be reduced, whereby costs can be decreased.

In addition, the sealing material 30 has a cross-sectional shape that tapers toward the housing 20. Hence, adjusting the cross-sectional shape (especially, the cross-sectional shape of a tapered tip portion) of the sealing material 30 can control the mode of elastic deformation of the sealing material 30, and furthermore can adjust the amount of reduction of the load applied to the ball bearing 22.

In addition, the sealing material 30 is annularly formed along the outer periphery of the case 26. Hence, while sealability of the space 52 for accommodating the substrate 28 is ensured, the load applied to the ball bearing 22 when the fan 14 is press-fitted can be reduced.

In addition, the cover portion 44 has flexibility. Hence, in the press-fitting process, when the shaft receiving portion 48 is deformed in the compression direction, the load applied to the ball bearing 22 can also be reduced by elastic deformation of the cover portion 44.

Next, modifications of the present embodiment will be described.

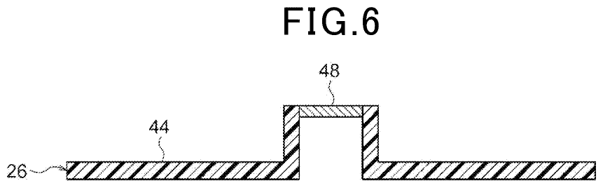

FIG. 6 is a longitudinal sectional view illustrating the case 26 according to a first modification. In the first modification, the shaft receiving portion 48 is formed of a metallic plate.

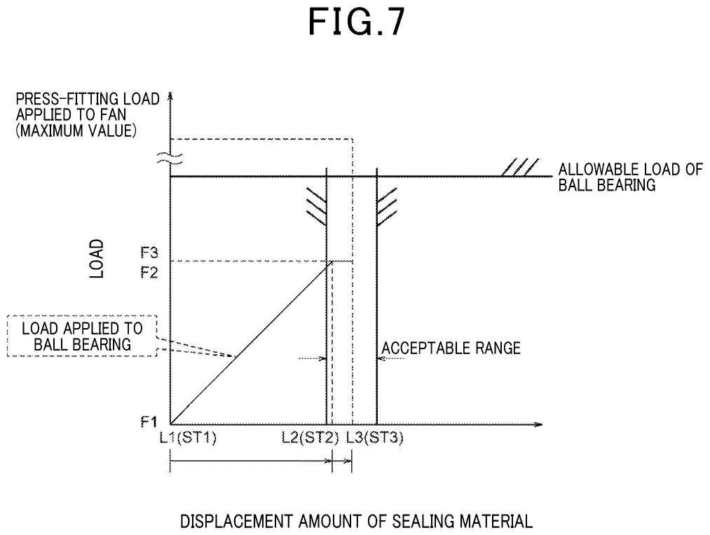

FIG. 7 is a graph illustrating a relationship between a displacement amount of the sealing material 30 and a load caused by the displacement of the sealing material 30 according to the first modification. In the first modification, since the shaft receiving portion 48 is formed of a metallic plate, from the second step ST2 to the third step ST3, the compressive deformation amount of the shaft receiving portion 48 is suppressed. Hence, from the second step ST2 to the third step ST3, increase of the load applied to the ball bearing 22 can be suppressed, whereby the load is kept constant.

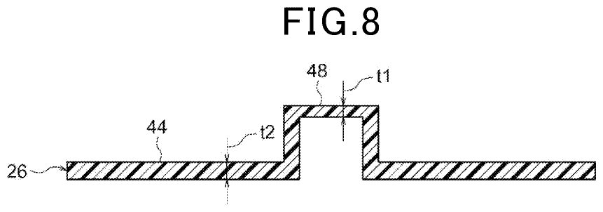

FIG. 8 is a longitudinal sectional view illustrating the case 26 according to a second modification. In the second modification, the shaft receiving portion 48 is thin-walled compared with the cover portion 44. That is, a thickness t1 of the shaft receiving portion 48 is smaller than a thickness t2 of the cover portion 44.

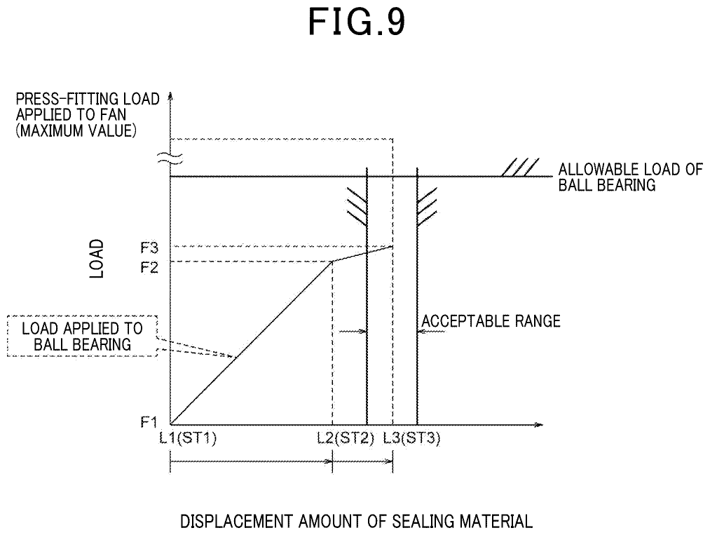

FIG. 9 is a graph illustrating a relationship between a displacement amount of the sealing material 30 and a load caused by the displacement of the sealing material 30 according to the second modification. In the second modification, since the shaft receiving portion 48 is thin-walled compared with the cover portion 44, from the second step ST2 to the third step ST3, the compressive deformation amount of the shaft receiving portion 48 is suppressed. Hence, from the second step ST2 to the third step ST3, increase of the load applied to the ball bearing 22 can be suppressed.

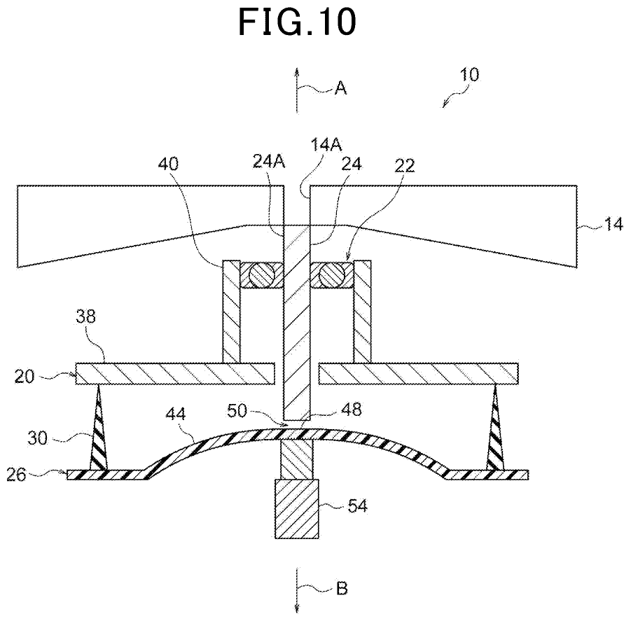

FIG. 10 is a longitudinal sectional view illustrating the motor device 10 according to a third modification. In the third modification, the cover portion 44 is formed continuously with the shaft receiving portion 48 and has a cross-sectional shape that convexly curves toward the housing 20.

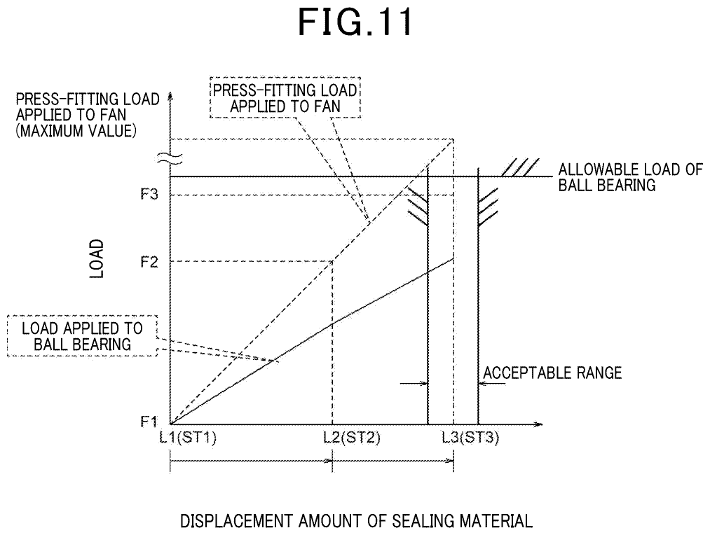

FIG. 11 is a graph illustrating a relationship between a displacement amount of the sealing material 30 and a load caused by the displacement of the sealing material 30 according to the third modification. In the third modification, since the cover portion 44 has a cross-sectional shape that convexly curves toward the housing 20, the cover portion 44 easily bends toward the B side compared with a case in which the cover portion 44 is formed into a flat plate shape. Hence, from the first step ST1 to the third step ST3, even when the shaft receiving portion 48 is deformed in the compression direction, the cover portion 44 bends, whereby increase of the load applied to the ball bearing 22 can be suppressed.

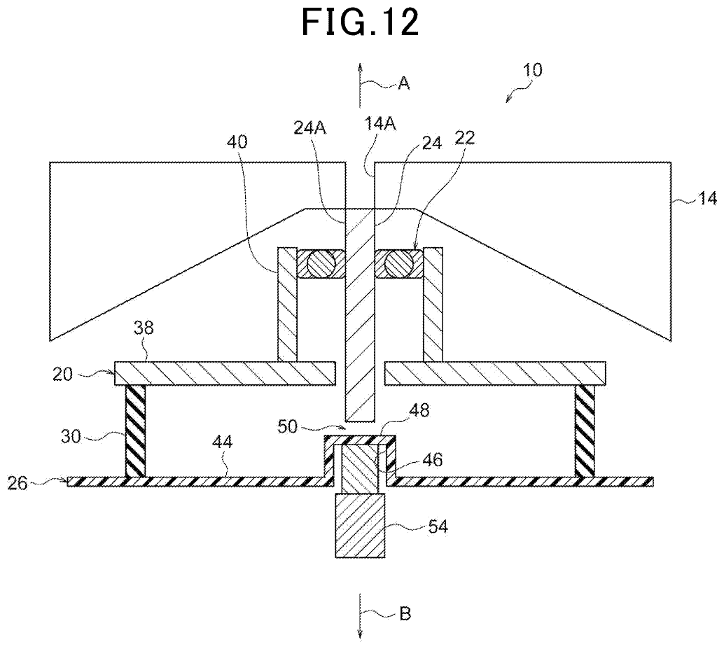

FIG. 12 is a longitudinal sectional view illustrating the motor device 10 according to a fourth modification. In the fourth modification, the sealing material 30 is formed to have a constant cross-section (i.e., constant thickness) along the axial direction of the shaft 24.

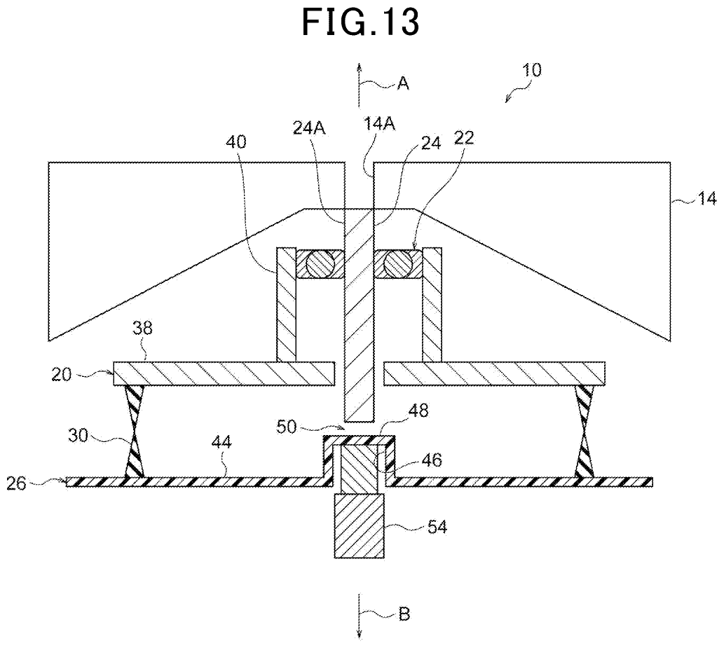

FIG. 13 is a longitudinal sectional view illustrating the motor device 10 according to a fifth modification. In the fifth modification, the sealing material 30 has a constricted cross-sectional shape when viewed in the direction orthogonal to the axial direction of the shaft 24 (i.e., the radial direction of the motor device 10).

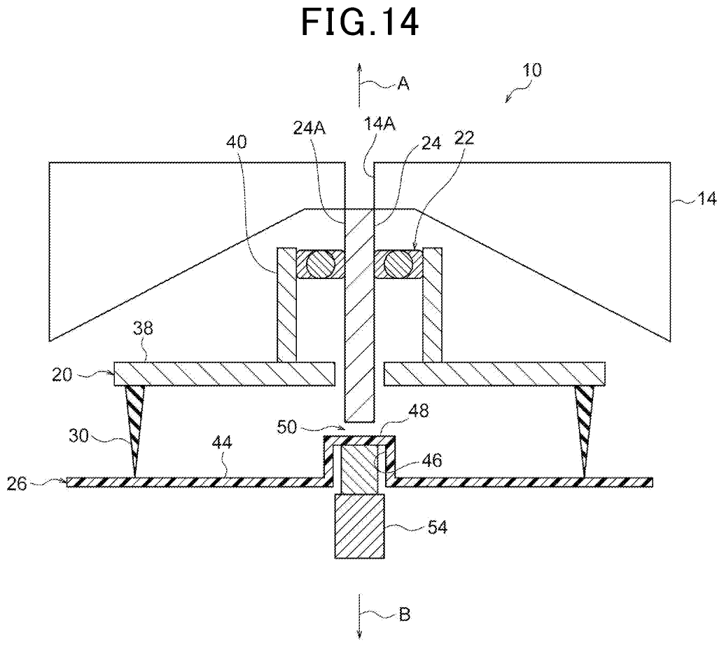

FIG. 14 is a longitudinal sectional view illustrating the motor device 10 according to a sixth modification. In the sixth modification, the sealing material 30 has a cross-sectional shape that tapers toward the opposite side of the housing 20 (i.e., the case 26 side).

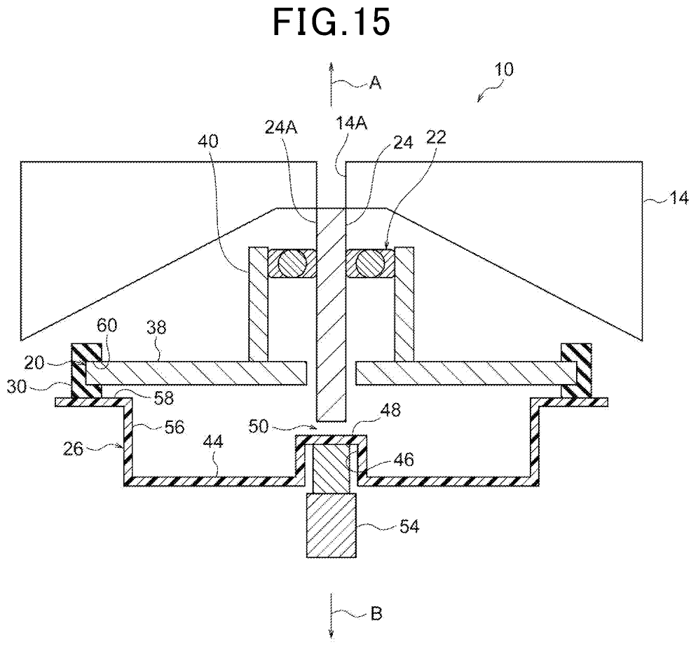

FIG. 15 is a longitudinal sectional view illustrating the motor device 10 according to a seventh modification. In the seventh modification, the cover portion 44 of the case 26 has a first extended portion 56 extending toward the base portion 38 and a second extended portion 58 extending from an end portion of the first extended portion 56 to the outside of the motor device 10 in the radial direction. The sealing material 30 is provided to the second extended portion 58 and is formed so as to have a constant cross-section (i.e., constant thickness) along the axial direction of the shaft 24. In the sealing material 30, a concave portion 60 opening to the shaft 24 side is formed. A radially outer end portion of the base section 38 is fitted into the concave portion 60. A portion of the sealing material 30 interposed between the housing 20 and the cover portion 44 is an example of the “intervening portion” of the present disclosure.

In addition, in the above embodiment, although the sealing material 30 having elasticity is provided between the housing 20 and the cover portion 44, the sealing material 30 having no elasticity may be provided. In addition, instead of the sealing material 30, a side wall extending from the cover portion 44 to the housing 20 may be provided. The side wall is an example of the “intervening portion” of the present disclosure.

In addition, in the above embodiment, although the annular sealing material 30 is provided between the housing 20 and the cover portion 44, a plurality of sealing materials 30 arranged along the outer periphery of the case 26 may be provided.

In addition, in the above embodiment, although the sealing material 30 is set to have lower rigidity than that of the cover portion 44, the sealing material 30 may be set to have higher rigidity than that of the cover portion 44.

In addition, in the above embodiment, although the motor device 10 includes the fan 14, the motor device 10 may include a rotary member other than the fan 14. In addition, the rotary member may be, for example, a driven member such as a gear.

In addition, the above plurality of modifications may be implemented in combination as appropriate.

Hereinbefore, although one embodiment of the present disclosure has been described, the present disclosure is not limited to the above. Instead of the above, needless to say, the present disclosure can be implemented with various modifications within a scope not deviating from the gist of the present disclosure.

The following supplementary notes are also provided regarding the present disclosure.

### Supplementary Note 1

A motor, including:
a housing that accommodates a ball bearing;
a shaft that is rotatably supported by the ball bearing and has a fixing portion at an end portion on one side of an axial direction of the shaft, a rotary member being fixed to the fixing portion by press-fitting;
a case that has a shaft receiving portion facing an end portion on the other side of the axial direction of the shaft via a gap, and a cover portion formed around the shaft receiving portion and having flexibility; and
an intervening portion that is interposed between the housing and the cover portion.

### Supplementary Note 2

The motor according to supplementary note 1, in which
the intervening portion has flexibility.

### Supplementary Note 3

The motor according to supplementary note 1 or supplementary note 2, in which
the intervening portion is a sealing material that seals a space between the housing and the cover portion.

### Supplementary Note 4

The motor according to supplementary note 3, in which
the sealing material has a cross-sectional shape that tapers toward the housing.

### Supplementary Note 5

The motor according to supplementary note 3 or supplementary note 4, in which
the sealing material is annularly formed along an outer periphery of the case.

### Supplementary Note 6

The motor according to any one of supplementary note 1 to supplementary note 5, in which
the shaft receiving portion is made of metal.

### Supplementary Note 7

The motor according to any one of supplementary note 1 to supplementary note 6, in which
the shaft receiving portion is thin-walled compared with the cover portion.

### Supplementary Note 8

The motor according to any one of supplementary note 1 to supplementary note 7, in which
the cover portion has a cross-sectional shape that convexly curves toward the housing.

### Supplementary Note 9

A motor device, including:
the motor according to any one of supplementary note 1 to supplementary note 8; and
the rotary member.

### Supplementary Note 10

A method of manufacturing the motor device according to supplementary note 9, including;
a press-fitting process of fixing the rotary member to the end portion on the one side of the axial direction of the shaft by press-fitting, in which
in the press-fitting process,
a load during press-fitting of the rotary member is transmitted to the cover portion via the ball bearing, the housing, and the intervening portion, thereby bending the cover portion to bring the end portion on the other side of the axial direction of the shaft, via the shaft receiving portion, into contact with a jig, and
completing the press-fitting of the rotary member while the end portion on the other side of the axial direction of the shaft is in contact with the jig via the shaft receiving portion.

### Supplementary Note 11

The method of manufacturing the motor device according to supplementary note 10, in which
the intervening portion has elasticity, and
the method further includes, in the press-fitting process, elastically deforming the intervening portion to reduce the load applied to the ball bearing.

### Supplementary Note 12

The method of manufacturing the motor device according to supplementary note or supplementary note 11, further including, in the press-fitting process, elastically deforming the cover portion to reduce the load applied to the ball bearing.

What is claimed is:

1. A motor, comprising:
a housing that has
a center piece which is formed in a cylindrical shape and configured to accommodate a ball bearing, and
a base portion which is formed around a base end portion of the center piece;
a shaft that is rotatably supported by the ball bearing and has a fixing portion at an end portion on one side of an axial direction of the shaft, a rotary member being fixed to the fixing portion by press-fitting;
a case that has
a bulging portion which is provided on a central axis of the motor and formed as a shaft receiving portion, a top portion of the bulging portion being configured to face an end portion on the other side of the axial direction of the shaft via a gap, and
a cover portion which is formed around a base end portion facing the top portion of the bulging portion in the axial direction of the shaft and has flexibility; and
an intervening portion that is interposed between the housing and the cover portion.

2. The motor according to claim 1, wherein
the intervening portion has flexibility.

3. The motor according to claim 1, wherein
the intervening portion is a sealing material that seals a space between the housing and the cover portion.

4. The motor according to claim 3, wherein
the sealing material has a cross-sectional shape that tapers toward the housing.

5. The motor according to claim 3, wherein
the sealing material is annularly formed along an outer periphery of the case.

6. The motor according to claim 1, wherein
the shaft receiving portion is made of metal.

7. The motor according to claim 1, wherein
the shaft receiving portion is thin-walled compared with the cover portion.

8. The motor according to claim 1, wherein
the cover portion has a cross-sectional shape that convexly curves toward the housing.

9. A motor device, comprising:
the motor according to claim 1; and
the rotary member.

10. A method of manufacturing the motor device according to claim 9, comprising;
a press-fitting process of fixing the rotary member to the end portion on the one side of the axial direction of the shaft by press-fitting, wherein
in the press-fitting process,
a load during press-fitting of the rotary member is transmitted to the cover portion via the ball bearing, the housing, and the intervening portion, thereby bending the cover portion to bring the end portion on the other side of the axial direction of the shaft, via the shaft receiving portion, into contact with a jig, and
completing the press-fitting of the rotary member while the end portion on the other side of the axial direction of the shaft is in contact with the jig via the shaft receiving portion.

11. The method of manufacturing the motor device according to claim 10, wherein
the intervening portion has elasticity, and
the method further comprises, in the press-fitting process, elastically deforming the intervening portion to reduce the load applied to the ball bearing.

12. The method of manufacturing the motor device according to claim 10, further comprising, in the press-fitting process, elastically deforming the cover portion to reduce the load applied to the ball bearing.
